(19) United States
(12) Patent Application Publication
(10) Pub. No.: US 2007/0231595 A1
(43) Pub. Date: Oct. 4, 2007

(54) Coatings for molybdenum-based substrates

(75) Inventors: Kenneth M. Tamaddoni-Jahromi, Carmel, IN (US); Brij Seth, Maitland, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/390,744

(22) Filed: Mar. 28, 2006

(51) Int. Cl. B32B 15/00; B05D 7/00

(52) U.S. Cl. 428/663; 427/402

(57) ABSTRACT

A coating for a molybdenum-based substrate that may be a bi-layer coating. The lower layer may include a first molybdenum coating compound, such as Mo₅Si₃, doped with from about 0 to about 10% boron and/or silicon. The upper layer may include a second molybdenum coating compound, such as MoSi₂, doped with from about 0 to about 20% silicon and/or aluminum. The bi-layer coating forms a protective SiO₂ surface upon high temperature exposure in oxygen-containing atmospheres. The coating is capable of providing long-term oxidation resistance to molybdenum-based substrates up to about 1400° C. An additional thermal layer may be included.

### FIELD OF THE INVENTION

This invention is directed generally to coatings for substrates, and more particularly to coatings for molybdenum-based substrates.

### BACKGROUND OF THE INVENTION

Molybdenum (Mo)-based materials are attractive for use in jet engines and other high temperature applications because they possess a combination of high thermal conductivity, low thermal expansion and excellent strength at temperatures up to 1250° C. In practice, however, the usefulness of molybdenum has been limited by its susceptibility to catastrophic oxidation. When molybdenum or molybdenum alloys are exposed to oxygen at temperatures in excess of about 600° C, the molybdenum is oxidized to molybdenum trioxide (MoO₃) and vaporized from the surface; resulting in shrinkage and eventually disintegration of the molybdenum or molybdenum alloy article.

Many previously disclosed methods of preventing oxidation of molybdenum at higher temperatures in oxidizing environments (such as air) have generally used a coating that is applied to the molybdenum alloy. Applied coatings are sometimes undesirable due to factors such as: poor adhesion, the need for extra manufacturing steps, and cost. Furthermore, damage to the coating may result in rapid oxidation of the underlying molybdenum alloy.

One such method to improve oxidation resistance of molybdenum or molybdenum alloys is a surface coating treatment, by which MoSi₂, which has an excellent oxidation resistance, is coated on the surface of the molybdenum substrate. One such process is the coating of a MoSi₂ layer using a low-pressure plasma spraying method. In this process, it is easy to form the alloy coating, but it is difficult to adjust the composition therefore resulting in a MoSi₂ coating having a plurality of defects in the coating.

Accordingly, what is needed is a coating for molybdenum-based substrates having enhanced oxidation resistance at high temperature. Also what is needed is a method of coating a molybdenum-based substrate to provide enhanced oxidation resistance at high temperatures.

### SUMMARY OF THE INVENTION

This present invention provides a coating for a molybdenum-based substrate. The coating may be a bi-layer coating for molybdenum substrates. The lower layer may include a first molybdenum coating compound doped with from about 0 to about 10% by weight of a first doping material. The upper layer may include a second molybdenum coating compound doped with from about 0 to about 20% by weight of a second doping material. The bi-layer coating is designed to form a protective SiO₂ surface upon high temperature exposure of the coated substrate to oxygen-containing atmospheres. The coating is capable of providing long-term oxidation resistance to molybdenum-based substrates up to about 1400° C.

Accordingly, in one aspect, the present invention provides a method for enhancing the oxidation resistance of molybdenum-based substrates including the step of applying a first coating to the molybdenum-based substrate and applying a second coating to the first coating. The first coating includes a first molybdenum coating compound having from about 80 to about 100% by weight of a first molybdenum compound and from about 0 to about 20% by weight of a first doping material selected from boron, silicon or a combination thereof. The second coating includes a second molybdenum coating compound having from about 70 to about 100% by weight of a second molybdenum compound and from about 0 to about 30% by weight of a second doping material selected from silicon, aluminum, or a combination thereof.

In another aspect, the present invention provides a molybdenum-based substrate having enhanced oxidation resistance including a molybdenum-based substrate, a first coating on the molybdenum-based substrate, and a second coating to the first coating. The first coating includes a first molybdenum coating compound having from about 80 to about 100% by weight of a first molybdenum compound and from about 0 to about 20% by weight of a first doping material selected from boron, silicon or a combination thereof and the second coating includes a second molybdenum coating compound having from about 70 to about 100% by weight of a second molybdenum compound and from about 0 to about 30% by weight of a second doping material selected from silicon, aluminum, or a combination thereof.

These and other embodiments are described in more detail below.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.” The present invention provides a coating for a substrate. In particular, the present invention provides coatings that may be used for molybdenum-based substrates. This coating may be a bi-layer coating. The lower layer may include a first molybdenum compound doped with a first doping material while the upper layer may include a second molybdenum compound doped with a second doping material. The bi-layer coating is designed to form a protective surface upon high temperature exposure of the coated substrate to oxygen-containing atmospheres. The coating is capable of providing long-term oxidation resistance to molybdenum-based substrates.

The present invention is directed to coatings of molybdenum and molybdenum alloys. Molybdenum is generally present in nature in the form of molybdenum sulphide and lead molybdate. Molybdenum is a hard transition metal, but is generally softer and more ductile than tungsten. It has a high elastic modulus, and only tungsten and tantalum, of the more readily available metals, have higher melting points. As such, molybdenum ,may be used in electrodes for electrically heated glass furnaces and fore hearths, nuclear energy applications, for missile and aircraft parts, high temperature lubricants, and other high temperature applications. As such, and since molybdenum oxidizes at higher temperatures, molybdenum has also been used in alloys.

Accordingly, in one embodiment of the present invention, the substrate may include 100% molybdenum. Nevertheless, molybdenum is a valuable alloying agent, as it contributes to the hardenability and toughness of quenched and tempered steels. It also improves the strength of steel at high temperatures. As such, molybdenum may be found in certain nickel-based alloys. Additionally, almost all ultra-high strength steels contain molybdenum in amounts from 0.25 to 8%. In general, as used herein, a “molybdenum alloy” is a molybdenum material from about 50 to about 99 weight % molybdenum and any additional material including, but not limited to, B, Si, C, Ti, Hf, Zr, W, Re, Al, Cr, Ni, V, Nb, Ta, or a combination thereof.

Molybdenum-based materials generally suffer from two mechanisms of catastrophic oxidation at elevated temperatures that result in low vapor pressure non-adherent MoO₃. In the 400-600° C. temperature range, “pesting” oxidation is dominant while in the T>600° C. range, another oxidation mechanism is active. By using the coatings of the present invention, the coatings provide long-term oxidation resistance of Mo-based materials from room temperature to about 1400° C.

The present invention provides a bi-layer coating for increased oxidation resistance for these molybdenum and molybdenum alloy substrates. In a first coating, the molybdenum and/or molybdenum alloy substrate is coated with a first molybdenum compound doped with a first doping material. The first molybdenum compound is, in one embodiment, a molybdenum-compound such as Mo₅Si₃.

The first molybdenum compound is doped with a first doping material. The doping material is included to increase the oxidation resistance of the first molybdenum compound coating and, therefore, the molybdenum substrate. In a first embodiment, the first doping material is selected from boron, silicon or a combination thereof. The addition of boron and/or silicon substantially improves oxidation resistance of Mo₅Si₃ over an elevated temperature range, e.g. from about 800 to about 1500° C. The boron and/or silicon help to provide a significant decrease in steady-state oxidation rate that occurs over a wide range of molybdenum compositions. The amount of the first doping material that may be used may vary, depending on a variety of factors including, but not limited to, the selected degree of oxidation resistance and/or the molybdenum compound used for the first coating. In one embodiment, the first doping material is added in an amount of from about 0 to about 20% by weight. In another embodiment, the first doping material is added in an amount of from about 0 to about 10% by weight.

The thickness of the first coating may vary. In general, the first coating is applied such that it covers the molybdenum substrate. The thickness of the first coating may be any thickness sufficient to provide the selected benefits to the molybdenum substrate. In a first embodiment, the first coating has a thickness of from about 50 to about 1000 μm.

The first coating may be applied using any known method for applying a coating to a substrate including, but not limited to, spraying, dipping, immersing or otherwise contacting the substrate with the coating material. In one embodiment, the coating methods may be selected from coating methods currently used in Ni-superalloy/MCrAlY (“metal”-chromium-aluminum-yttrium) systems. Examples of such methods include, but are not limited to, vacuum plasma spraying (VPS), low pressure plasma spraying (LPPS), high velocity oxygen fuel spraying (HVOF), or air plasma spraying (APS).

In one embodiment, the first coating is applied using a thermal spray method. Thermal spray coating and forming is a process where a coating is applied to the surface of the molybdenum substrate. In addition, thermal spraying may be used to layer dissimilar coating materials so that their desired properties work together.

Vacuum plasma spraying, low pressure plasma spraying and air plasma spraying may be used to apply materials in thick layers. In a vacuum, inert or air environment, plasma is generated by ionizing gas via an internally conducted arc and accelerates the coating material through a plasma flame to the substrate.

High-velocity oxyfuel spray may be used to apply many material types. A supersonic gas velocity from a combustion process propels the powder. The powder then melts as it passes through a flame and is deposited on the substrate surface. The kinetic energy results in a dense, well-adhered coating.

In addition to the first coating, the molybdenum and/or molybdenum alloy substrate is coated with a second coating including a second molybdenum compound doped with a second doping material. The second molybdenum compound is, in one embodiment, a molybdenum compound such as MoSi₂.

The second doping material is included to increase the oxidation resistance of the second molybdenum compound coating and, therefore, the molybdenum substrate. In a first embodiment, the second doping material is selected from silicon, aluminum, or a combination thereof. The addition of the second doping material is also used to improve the oxidation resistance of MoSi₂. The amount of the second doping material that may be used may vary, depending on a variety of factors including, but not limited to, the selected degree of oxidation resistance and/or the molybdenum compound used for the second coating. In one embodiment, the second doping material is added in an amount of from about 0 to about 30% by weight. In another embodiment, the second doping material is added in an amount of from about 0 to about 20% by weight.

The thickness of the second coating may vary. In general, the second coating is applied such that it covers the first coating. The thickness of the coating may be any thickness sufficient to provide the selected benefits to the molybdenum substrate. In a first embodiment, the second coating has a thickness of from about 50 to about 1000 μm.

As with the first coating, the second coating may be applied using any known method for applying a coating to a substrate including, but not limited to, spraying, dipping, immersing or otherwise contacting the substrate with the coating material. In one embodiment, the second coating is applied using a thermal spray method such as vacuum plasma spraying, low pressure plasma spraying, high velocity oxyfuel spraying, or air plasma spraying.

The coatings of the present invention are selected to provide oxidation protection of molybdenum-based materials from room temperature to about 1400° C. In addition, the coatings of the present invention may be selected such that they have “self-healing” capability. As such, damage that may occur to the coating during use will not result in catastrophic failure of the coating or the substrate.

In addition, the coatings may be selected such that they are thermodynamically stable with each other. As such, there would be no phase instability with long-term exposure of the coating and/or substrate to high temperatures.

In picking the coating, it may be beneficial, in one embodiment, to match the substrate with the thermal coatings to result in a good coefficient of thermal expansion (CTE) match. A good CTE match results in low thermal stresses/strains in the coating system. Excellent coating adherence may be realized due to the low strains.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A method for enhancing the oxidation resistance of molybdenum-based substrate comprising the step of:
providing a molybdenum-based substrate;
applying a first coating to the molybdenum-based substrate; and
applying a second coating to the first coating;
wherein the first coating comprises a first molybdenum coating compound having from about 80 to about 100% by weight of a first molybdenum compound and from about 0 to about 20% by weight of a first doping material selected from boron, silicon or a combination thereof;
wherein the second coating comprises a second molybdenum coating compound having from about 70 to about 100% by weight of a second molybdenum compound and from about 0 to about 30% by weight of a second doping material selected from silicon, aluminum, or a combination thereof.

2. The method of claim 1, wherein the molybdenum-based substrate is selected from a compound having from about 50% to about 100% by weight of molybdenum and from 0 to about 50% by weight of a material selected from B, Si, C, Ti, Hf, Zr, W, Re, Al, Cr, Ni, V, Nb, Ta, or a combination thereof.

3. The method of claim 1, wherein the first molybdenum coating compound is Mo₅Si₃.

4. The method of claim 1, wherein the second molybdenum coating compound is MoSi₂.

5. The method of claim 1, wherein the first coating comprises from about 90 to about 100% by weight of the first molybdenum compound and from about 0 to about 10% by weight of the first doping material.

6. The method of claim 1, wherein the second coating comprises from about 80 to about 100% by weight of the second molybdenum compound and from about 0 to about 20% by weight of the second doping material.

7. The method of claim 1, wherein the first coating has a thickness of from about 50 μm to about 1000 μm.

8. The method of claim 1, wherein the second coating has a thickness of from about 50 μm to about 1000 μm.

9. The method of claim 1, wherein the coated molybdenum-based substrate has enhanced oxidation resistance in temperatures up to about 1400° C.

10. A molybdenum-based substrate having enhanced oxidation resistance comprising:
a molybdenum-based substrate;
a first coating on the molybdenum-based substrate; and
a second coating to the first coating;
wherein the first coating comprises a first molybdenum coating compound having from about 80 to about 100% by weight of the first molybdenum compound and from about 0 to about 20% by weight of a first doping material selected from boron, silicon or a combination thereof;
wherein the second coating comprises a second molybdenum coating compound having from about 70 to about 100% by weight of the second molybdenum compound and from about 0 to about 30% by weight of a second doping material selected from silicon, aluminum, or a combination thereof.

11. The substrate of claim 10, wherein the molybdenum-based substrate is selected from a compound having from about 50% to about 100% by weight of molybdenum and from 0 to about 50% by weight of a material selected from B, Si, C, Ti, Hf, Zr, W, Re, Al, Cr, Ni, V, Nb, Ta, or a combination thereof.

12. The substrate of claim 10, wherein the first molybdenum compound is Mo₅Si₃.

13. The substrate of claim 10, wherein the second molybdenum compound is MoSi₂.

14. The substrate of claim 10, wherein the first coating comprises from about 90 to about 100% by weight of the first molybdenum compound and from about 0 to about 10% by weight of the first doping material.

15. The substrate of claim 10, wherein the second coating comprises from about 80 to about 100% by weight of the second molybdenum compound and from about 0 to about 20% by weight of the second doping material.

16. The substrate of claim 10, wherein the first coating has a thickness of from about 50 μm to about 1000 μm.

17. The substrate of claim 10, wherein the second coating has a thickness of from about 50 μm to about 1000 μm.

18. The substrate of claim 10, wherein the coated molybdenum-based substrate has enhanced oxidation resistance in temperatures up to about 1400° C.

19. A coating for a molybdenum-based substrate comprising:
a first coating on the molybdenum-based substrate; and
a second coating to the first coating;
wherein the first coating comprises a first molybdenum coating compound having from about 80 to about 100% by weight of a first molybdenum compound and from about 0 to about 20% by weight of a first doping material selected from boron, silicon or a combination thereof;
wherein the second coating comprises a second molybdenum coating compound having from about 70 to about 100% by weight of the second molybdenum compound and from about 0 to about 30% by weight of a second doping material selected from silicon, aluminum, or a combination thereof.

20. The coating of claim 19, wherein the coated molybdenum-based substrate has enhanced oxidation resistance in temperatures up to about 1400° C.
